(19) United States
(12) Patent Application Publication
(10) Pub. No.: US 2010/0250933 A1
(43) Pub. Date: Sep. 30, 2010

(54) COMMUNICATION APPARATUS

(75) Inventor: Hiroyuki KAMIO, Tachikawa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/697,860

(22) Filed: Feb. 1, 2010

(30) Foreign Application Priority Data
Mar. 30, 2009 (JP) 2009-082348

(51) Int. Cl. H04L 9/32; H04L 9/08

(52) U.S. Cl. 713/168; 380/278

(57) ABSTRACT

A communication apparatus including: a communication module configured to establish communication with a counterpart device and receive and transmit a content from and to the counterpart device; a storage configured to store the content; a first processor configured to perform decryption and encryption on the content using a first key that is unique to the communication apparatus; a second processor configured to perform decryption and encryption on the content using a second key that is unique to the content; and a controller configured to control the second processor to perform the encryption on the content stored in the storage when transmitting the content to the counterpart device, and to control the first processor to perform the encryption on the content received from the counterpart device and decrypted by the second processor when storing the content in the storage.

### CROSS REFERENCE TO RELATED APPLICATION(S)

The present disclosure relates to the subject matters contained in Japanese Patent Application No. 2009-082348 filed on Mar. 30, 2009, which are incorporated herein by reference in its entirety.

### FIELD

The present invention relates to a communication apparatus to be used in a content distribution system, and the content distribution system.

### BACKGROUND

Web-based information delivery has been widely used on the Internet, and the Internet is spreading as the new distribution aspect of contents. As the protection measure of the contents on the Internet, there has been disclosed a key delivery system wherein, as disclosed in, for example, a related-art document JP-A-2004-282116, encrypted contents are delivered, and decryption keys necessary for decrypting the encrypted contents are delivered and managed.

In the key delivery system mentioned above, downloaded contents are stored in the device of a user in an encrypted state. In order to reproduce the downloaded contents, therefore, it is required to connect the device to the Internet again and to acquire the decryption key of the contents. Accordingly, the user must connect his/her device to the Internet each time the contents are to be reproduced, and this is troublesome. On the other hand, when contents are stored in a decrypted plaintext state, it is apprehended that the contents will be circulated to another device from the user's device into which they have been downloaded.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a general view of a content distribution system in an embodiment of the present invention.

FIG. 2 is a functional block diagram of a terminal device in the embodiment of the invention.

FIG. 3 is a diagram showing the steps of the upload of contents in the embodiment of the invention.

FIG. 4 is a sequence diagram of the upload in the embodiment of the invention.

FIG. 5 is a conceptual diagram of the storage state of a key delivery server in the embodiment of the invention.

FIG. 6 is a conceptual diagram of the storage state of a content management server in the embodiment of the invention.

FIG. 7 is a flow chart showing the steps of the upload of contents in the embodiment of the invention.

FIG. 8 is a flow chart showing the operation of a key delivery server in the embodiment of the invention.

FIG. 9 is a diagram showing a method for downloading contents in the embodiment of the invention.

FIG. 10 is a sequence diagram of the download in the embodiment of the invention.

FIG. 11 is a flowchart showing the steps of the download of the contents in the embodiment of the invention.

### DETAILED DESCRIPTION OF THE EMBODIMENTS

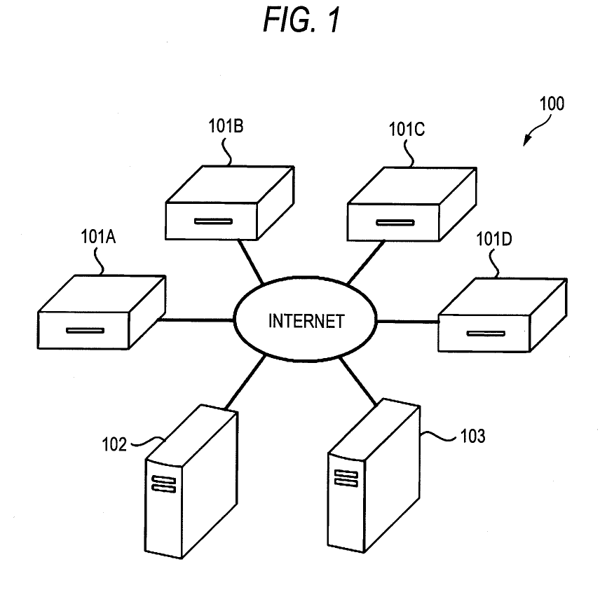

An embodiment of the present invention will be described with reference to FIGS. 1-11. First, the outline of a content distribution system 100 according to the invention will be described with reference to FIG. 1. FIG. 1 is a general view of the content distribution system 100 according to the embodiment of the invention.

The content distribution system 100 is so configured that a plurality of terminal devices 101, a content management server 102 and a key delivery server 103 are connected to the Internet. In FIG. 1, four terminal devices 101 (terminal device 101A, terminal device 101B, terminal device 101C and terminal device 101D) are shown as an example of the plurality of terminal devices 101. The respective terminal devices 101 have equivalent functions.

The terminal devices 101 build a P2P (Peer to Peer) network with the other terminal devices 101 which are connected to the Internet. The “P2P network” transmits and receives contents by exchanging fragmental content data (hereinafter, termed the “pieces”) among the plurality of terminal devices 101. In a case, for example, where requests for downloading the contents possessed by the terminal device 101A have been made by the terminal devices 101B and 101C, the terminal device 101A allocates the pieces different from each other, to the terminal devices 101B and 101C. Thereafter, the terminal devices 101B and 101C complete the contents by exchanging the pieces which they do not possess, respectively. That is, one content item is downloaded via the plurality of terminal devices 101, thereby to make a contrivance in which the load of communications does not concentrate on the specified terminal device 101. In a case where a download request for the pertinent contents has been made by the new terminal device 101D in this state, the three devices of the terminal devices 101A, 101B and 101C possess the contents at that time point, respectively. In this case, the terminal device 101D which desires the download of the pertinent contents receives the pieces possessed by the respective terminal devices 101, from the three devices, so as to collect all the data of the pertinent contents. Here in this specification, the P2P network shall be utilized for the delivery of the contents, and the expression “contents” shall hereinafter signify non-encrypted contents on which the limitation of copying is not imposed.

The content management server 102 stores therein content information items transmitted from the terminal devices 101 which belong to the content distribution system 100, and it delivers a public content list. The “content information items” are content IDs which are the identifiers of the contents, and the addresses of the terminal devices 101 which possess the pertinent contents. The “public content list” signifies data in which the content IDs of the contents opened to the public onto the Internet by the terminal devices 101, and the addresses of the terminal devices 101 possessing the pertinent contents, are listed.

In a case where the contents are uploaded from any of the terminal devices 101, the key delivery server 103 issues a content key Kc in association with the contents, and it delivers an encryption key EKc encrypted using a device key Kd unique to the terminal device 101. On that occasion, the fee of the upload is charged on the terminal device 101. The fee of the upload is a handling fee for issuing the content key Kc, and the fee collected in the case of the upload is paid to the managers of the content management server 102 and the key delivery server 103. In a case where the contents are downloaded from any of the terminal devices 101, the key delivery server 103 generates an encryption key EKc in such a way that the content key Kc corresponding to the content ID of the pertinent contents is encrypted using a received device key Kd, and it delivers the generated encryption key EKc to the terminal device 101. On that occasion, the fee of the content download is charged. The fee collected from the terminal device 101 which has downloaded the contents is paid to the user of the terminal device 101 which has uploaded the pertinent contents. A system for accounting will be stated later.

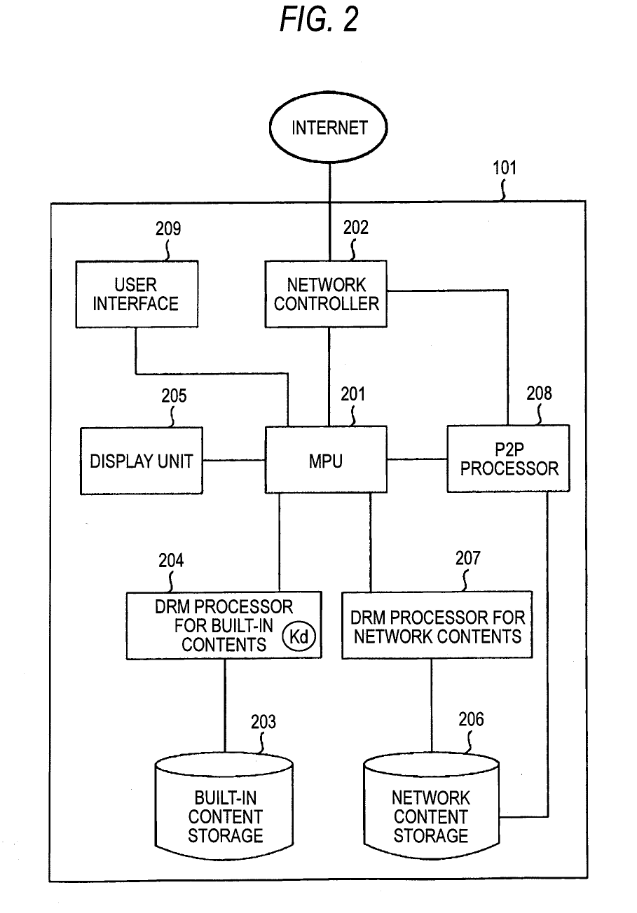

Next, the functions of each terminal device 101 will be described with reference to FIG. 2. FIG. 2 is a functional block diagram of the terminal device 101 in the embodiment of the present invention.

The terminal device 101 is configured of an MPU (Micro Processor) 201, a network controller 202, a built-in content storage 203, a DRM processor for built-in contents, 204, a display interface 205, a storage unit for network contents, 206, a DRM processor for the network contents, 207, a P2P processor 208, and a user interface 209.

The MPU 201 is a processor which is disposed for controlling the operation of the whole terminal device 101, and which runs an operating system and various application programs that are loaded into its memory from a storage device not shown.

The network controller 202 establishes communication between counterpart device through a wired or wireless network. This network controller 202 serves as a communication unit which establishes communication with the Internet through an external router or the like.

The built-in content storage 203 is a storage device which stores therein built-in contents such as contents created using the terminal device 101 itself and contents downloaded from the Internet. This built-in content storage 203 may be configured by, for example, an HDD (Hard Disk Drive) or a memory.

The DRM processor for the built-in contents, 204 performs the encryption and decryption of the contents which are stored in the built-in content storage 203. This DRM processor for the built-in contents, 204 is set so as to perform the decryption and encryption by using the device key Kd unique to the terminal device 101.

The display interface 205 reproduces contents stored in the built-in content storage 203 or the storage unit for the network contents, 206, in compliance with the instruction of the MPU 201. This display interface 205 is connected with a television receiver or the like display device through, for example, an external output terminal.

The storage unit for the network contents, 206 is a storage device for storing the network contents therein, which uploads the contents onto the Internet through the network controller 202 and the P2P processor 208 or which downloads the contents from the Internet. This storage unit for the network contents, 206 is, for example, an HDD or a memory, and it may well be defined in the same device with the built-in content storage 203 by being divided into partitions. The built-in contents and the network contents may well be categorized into separate folders, or they may well be categorized with different extensions.

The DRM processor for the network contents, 207 performs the encryption and decryption of the contents which are stored in the storage unit for the network contents, 206. Incidentally, this DRM processor for the network contents, 207 may well be configured by a component shared with the DRM processor for the built-in contents, 204.

The P2P processor 208 transmits or receives the contents through the network controller 202 and the P2P network. In transmitting the contents, this P2P processor 208 allocates the contents stored in the storage unit for the network contents, 206, as the pieces. In receiving the contents, this P2P processor 208 collects the pieces of the contents as collected from the other terminal device 101 and then stores the collected pieces in the storage unit for the network contents, 206 in succession.

The user interface 209 transfers a command input by of the user to the MPU 201. This user interface 209 may be disposed in the body of the terminal device 101, or it may well receive a command signal which indicates a command made by the user from a remote controller now shown, by an infrared communication or the like.

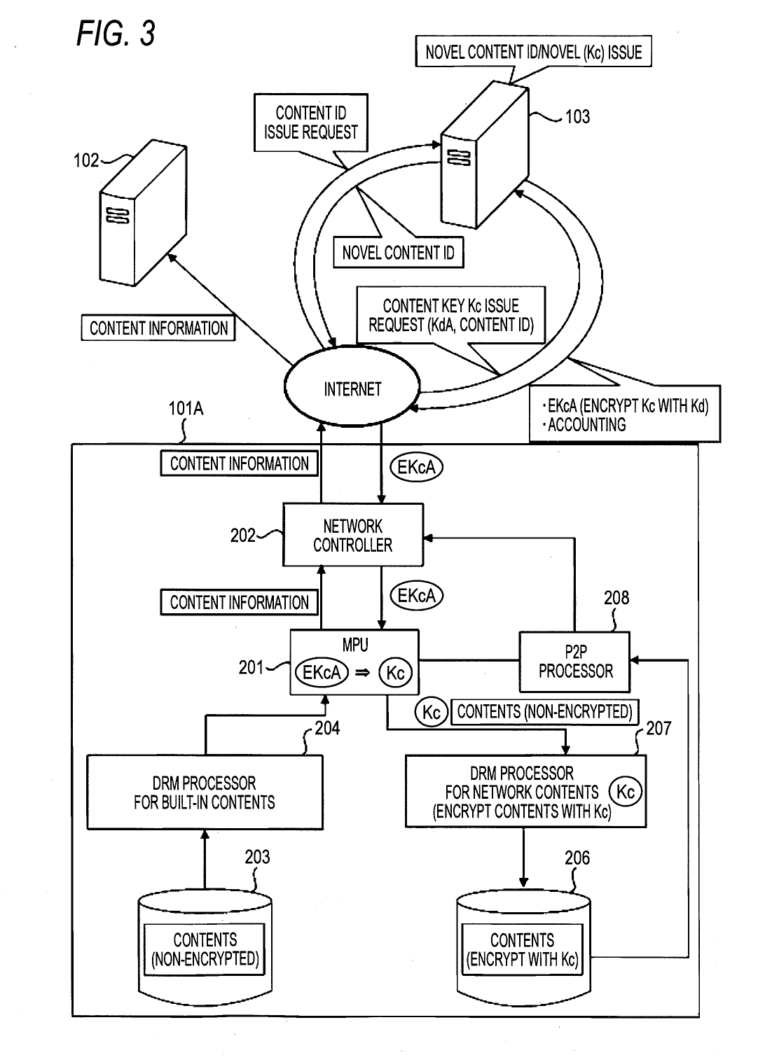

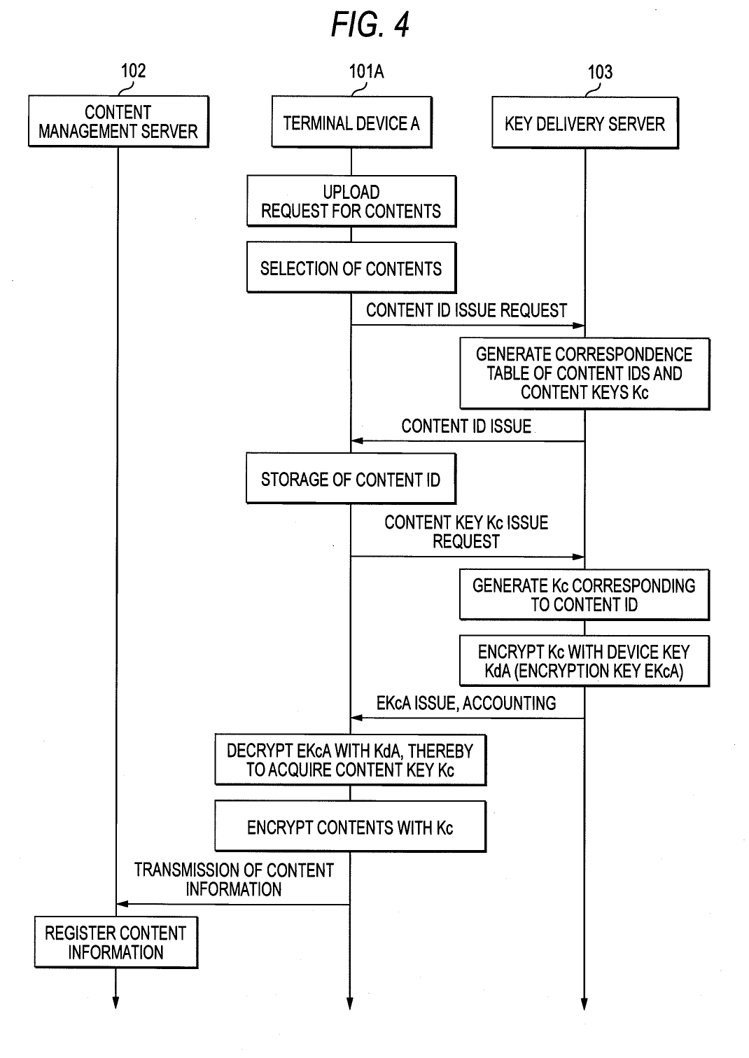

Next, the steps of uploading the built-in contents onto the Internet will be described with reference to FIGS. 3 and 4. FIG. 3 is a diagram showing the steps of uploading the contents in the embodiment of the present invention. FIG. 4 is a sequence diagram of the upload in the embodiment of the invention. Here in this specification, the terminal device 101A shall be exemplified as the terminal device 101 for the upload, and the terminal device 101B as the terminal device 101 for the download.

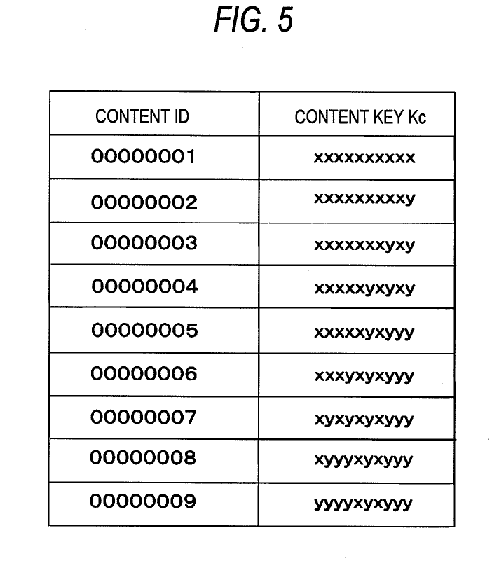

First, in the terminal device 101A, an upload request for the contents is checked, and the contents to be uploaded are selected from among the built-in contents stored in the built-in content storage 203. Subsequently, the terminal device 101A requests the key delivery server 103 to issue a content ID. Then, the key delivery server 103 issues the content ID being an identifier unique to the pertinent contents, in response to the issue request. On this occasion, the key delivery server 103 generates a table for storing the issued content ID and a content key Kc in association. An aspect as shown in FIG. 5 is considered as the storage state of the key delivery server 103. FIG. 5 is a conceptual diagram of the storage state of the key delivery server 103 in the embodiment of the present invention. Content IDs indicated in the left column of FIG. 5, and content keys Kc indicated in the right column of the figure are stored so as to generate a table. On the other hand, the terminal device 101A which has received the content ID issued by the key delivery server 103 stores the content ID in the MPU 201.

Subsequently, the terminal device 101A makes a request for the issue of the content key Kc. In compliance with the request for issuing the content key Kc, the issued content ID and a device key KdA stored in the DRM processor for the built-in contents, 204 are transmitted to the key delivery server 103. Then, the key delivery server 103 generates the content key Kc in association with the received content ID, and it stores the content key Kc in the table.

Subsequently, the key delivery server 103 encrypts the content key Kc generated in association with the content ID, by using the device key KdA received from the terminal device 101A, thereby to generate an encryption key EKcA.

Subsequently, the key delivery server 103 transmits the generated encryption key EKcA to the terminal device 101A and simultaneously makes accounting. The account No. or the like of an account such as bank account, from which a fee can be received is registered in the key delivery server 103 beforehand, and the predetermined amount of money is pulled down from the account specified from the registered account No.

In a case where the contents have been downloaded from the other terminal device 101, that is, where the non-free contents have been purchased, the charge of the pertinent contents is paid into the account.

Subsequently, the key delivery server 103 transmits the encryption key EKcA to the terminal device 101A. The operation of the terminal device 101A after the reception of the encryption key EKcA will be described with reference to FIG. 3. First, the terminal device 101A receives the encryption key EKcA through the network controller 202 and transmits this encryption key to the MPU 201. The MPU 201 decrypts the received encryption key EKcA by using the device key KdA stored in the DRM processor for the built-in contents, 204, thereby to acquire the content key Kc. In addition, the MPU 201 sets the DRM processor for the network contents, 207 so as to perform encryption by using the content key Kc.

Subsequently, the DRM processor for the network contents, 207 reads out the contents stored in the built-in content storage 203. In addition, it encrypts the contents by using the set content key Kc and stores the encrypted contents in the storage unit for the network contents, 206. The contents stored in the storage unit for the network contents, 206 are divided into pieces by the P2P processor 208, and the pieces are delivered through the Internet in a case where a download request has been received.

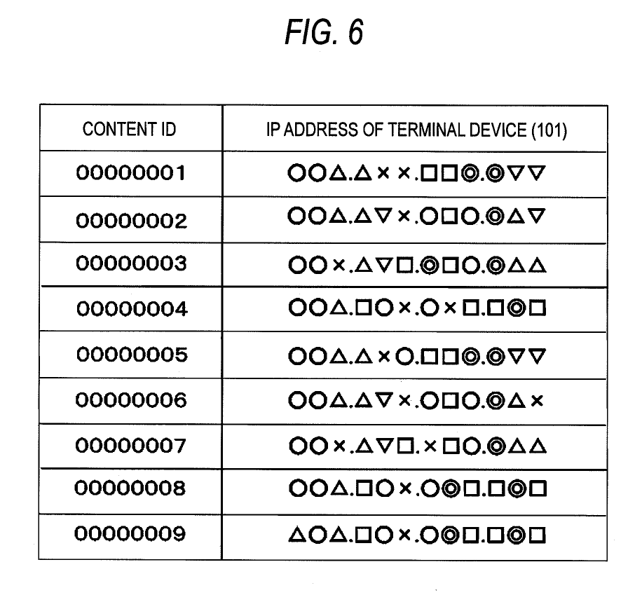

The MPU 201 registers in the content management server 102, the content information items of the contents stored in the storage unit for the network contents, 206. The content information items are the content ID and the IP address of the terminal device 101A. An aspect as shown in FIG. 6 is considered as the storage state of the content management server 102 here. FIG. 6 is a conceptual diagram of the storage state of the content management server 102 in the embodiment of the present invention. The content IDs indicated in the left column of FIG. 6, and the IP addresses of the terminal devices 101 as indicated in the right column of the figure are stored so as to generate a table. Incidentally, although the IP addresses have been exemplified here in this specification, another aspect may well be employed as long as the terminal devices 101 can be identified.

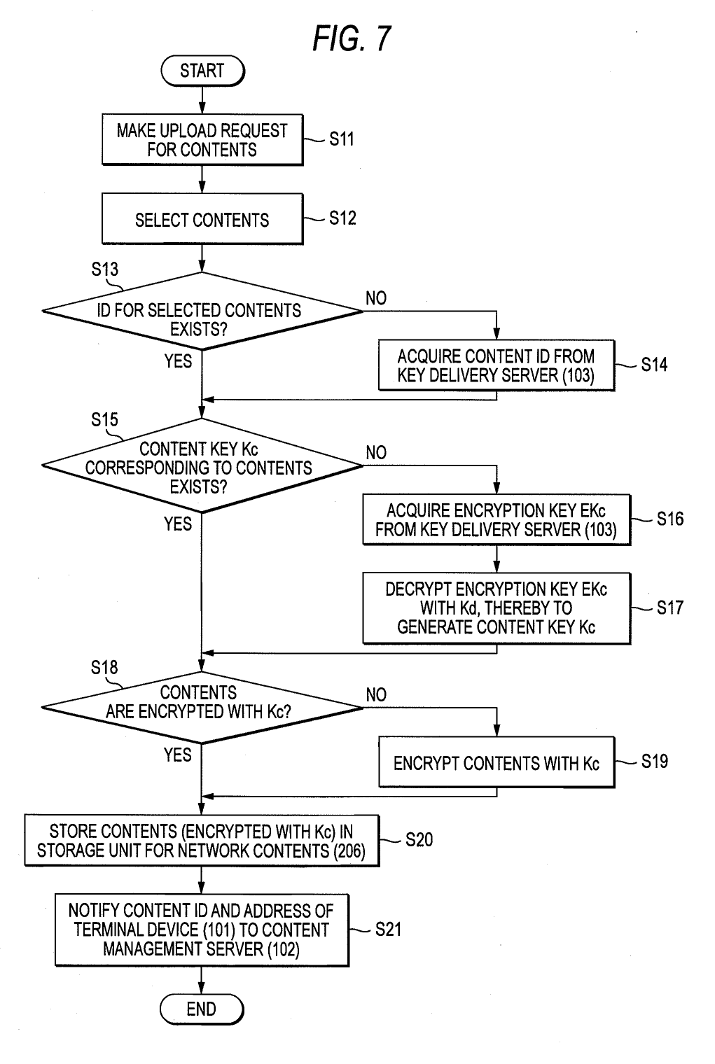

Next, the operation of the terminal device 101 in the case of uploading contents will be described with reference to FIG. 7. FIG. 7 is a flow chart showing the steps of uploading the contents in the embodiment of the present invention.

First, the MPU 201 confirms that a request for the upload of the contents has been made by the user interface 209 (step S11). Subsequently, the MPU 201 confirms that the contents to be uploaded have been selected from among contents stored in the built-in content storage 203, by the user interface 209 (step S12).

Subsequently, the MPU 201 determines whether or not a content ID corresponding to the selected contents is stored (step S13). When it has consequently been determined that the content ID is not stored (“No” at step S13), the terminal device 101 requests the key delivery server 103 to issue the content ID and acquires this content ID (step S14). On the other hand, when determined that the content ID is stored (“Yes” at step S13), the MPU 201 subsequently determines whether or not a content key Kc corresponding to the content ID of the selected contents is stored (step S15).

When it has consequently been determined that the content key Kc is not stored in the MPU 201 (“No” at step S15), the MPU 201 transmits the selected content ID and a device key Kd stored in the DRM processor for the built-in contents, 204, to the key delivery server 103. In addition, an encryption key EKc which is obtained in such a way that the contents Kc corresponding to the content ID are encrypted using the transmitted device key Kd, is received from the key delivery server 103 (step S16). Subsequently, the MPU 201 decrypts the received encryption key EKc by using the device key Kd stored in the DRM processor for the built-in contents, 204, thereby to acquire the content key Kc (step S17).

On the other hand, when determined that the content key Kc is stored in the MPU 201 (“Yes” at step S15), the MPU 201 subsequently determines whether or not the selected contents have been encrypted with the content key Kc (step S18).

When consequently determined that the selected contents have not been encrypted with the content key Kc (“No” at step S18), the MPU 201 subsequently reads out the contents selected from the built-in content storage 203 and encrypts them with the content key Kc by the DRM processor for the network contents, 207 (step S19).

On the other hand, when determined that the selected contents have been encrypted with the content key Kc (“Yes” at step S18), the MPU 201 subsequently stores the contents encrypted by the DRM processor for the network contents, 207, in the storage unit for the network contents, 206 (step S20).

Subsequently, the MPU 201 notifies the content ID and the address of the terminal device 101 to the content management server 102 (step S21). The various information items of the uploaded contents are registered in the content management server 102. The information items are, for example, the title and capacity of the contents, and a fee in the case of downloading the contents.

The steps of uploading the contents stored in the terminal device 101, onto the Internet are ended by the above steps.

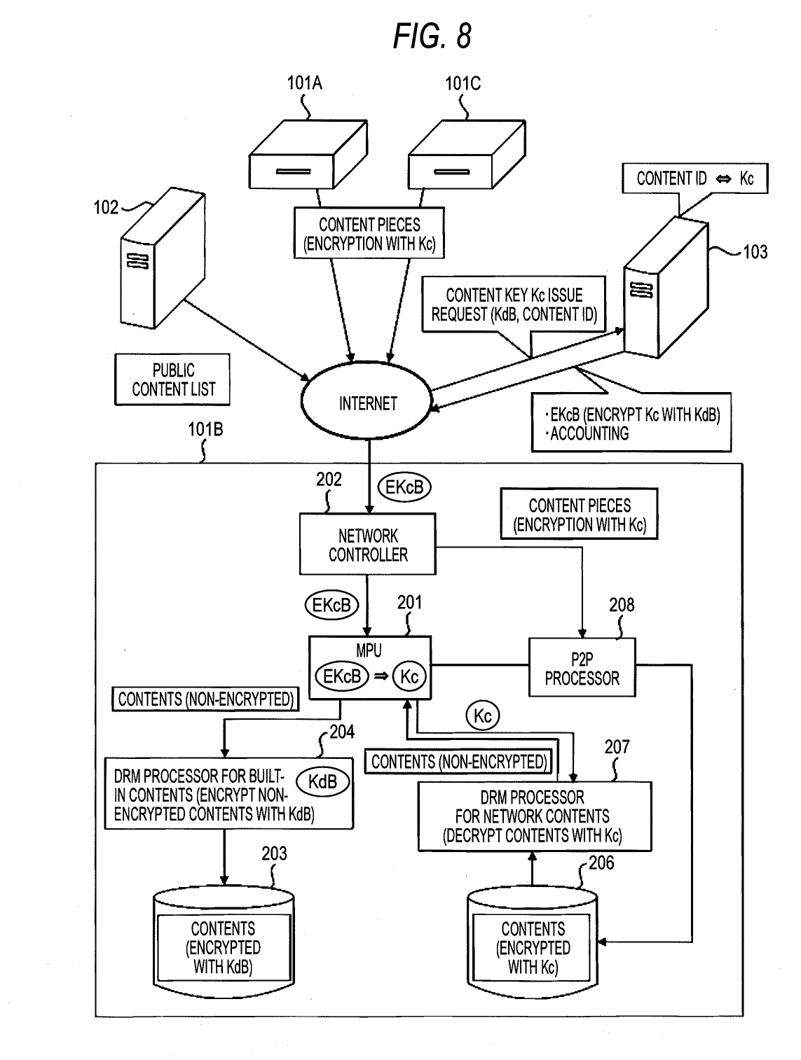

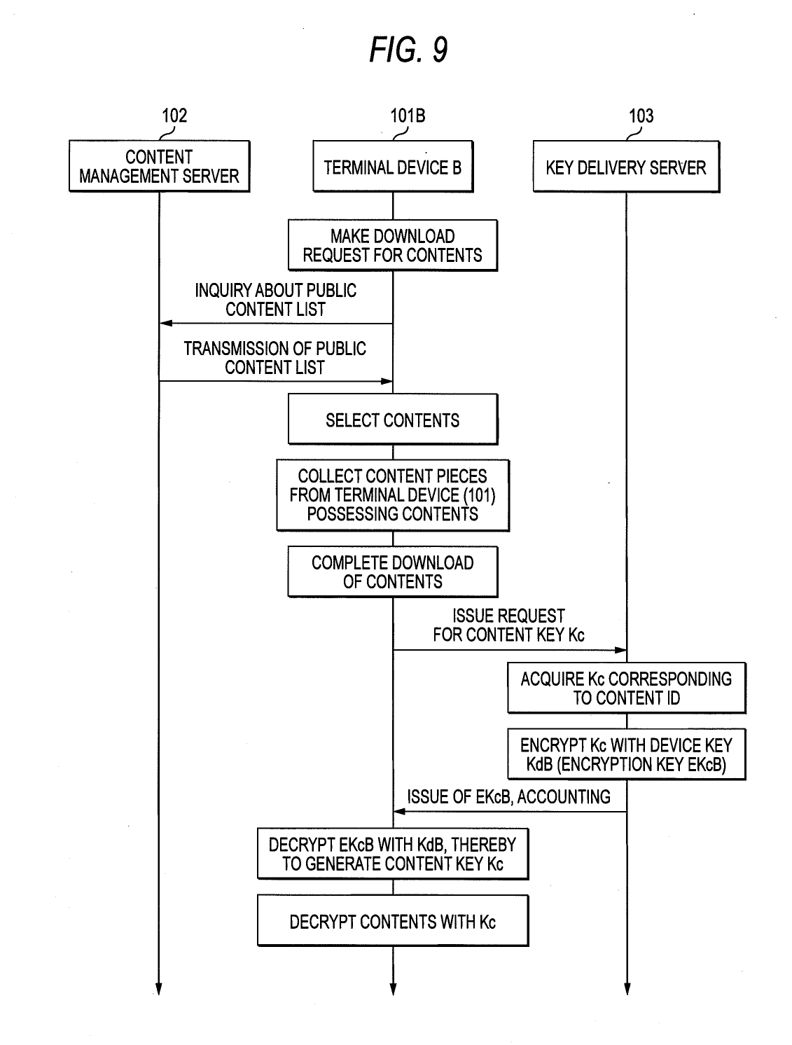

Next, the steps of downloading public contents from on the Internet will be described with reference to FIGS. 8 and 9. FIG. 8 is a diagram showing a method for downloading the contents in the embodiment of the present invention. FIG. 9 is a sequence diagram of the download in the embodiment of the invention. In this embodiment, there will be exemplified a case where the terminal device 101B downloads the contents uploaded from the terminal device 101A. Also, there is held a state where the pieces of the contents to be downloaded are allocated through a P2P network, and where the terminal devices 101A and 101C possess the pieces.

First, the terminal device 101B confirms a request for downloading the contents and inquires of the content management server 102 about the list of public contents. It acquires the public content list from the content management server 102.

Subsequently, the terminal device 101B selects the contents to-be-downloaded from within the acquired public content list. The pieces of the contents are collected from the terminal devices 101A and 101C which have the selected contents. The collection of the pieces is done in such a way that the function of the P2P processor 208 is executed. A state where all the data of the contents have been completed by collecting the pieces of the contents, is a state where the download of the contents has been finished up.

Next, the operation of the terminal device 101B after the contents have been downloaded into the storage unit for the network contents, 206, will be described with reference to FIG. 8. The terminal device 101B makes a request for the issue of a content key Kc. In the issue request for the content key Kc, the content ID of the downloaded contents and the device key KdB of the pertinent device 101B are transmitted to the key delivery server 103. Then, the key delivery server 103 acquires the content key Kc corresponding to the received content ID, from the stored table thereof. Subsequently, the key delivery server 103 encrypts the content key Kc by using the received device key KdB, thereby to generate an encryption key EKcB. Further, the key delivery server 103 transmits the generated encryption key EKcB to the terminal device 101B and simultaneously charges a fee on this terminal device 101B. Since a charging method has already been stated, it shall be omitted from description. The charged fee is paid to the terminal device 101A having uploaded the pertinent contents.

Subsequently, the MPU 201 receives the encryption key EKcB through the network controller 202, and it decrypts the encryption key EKcB by using the device key KdB stored in the DRM processor for the built-in contents, 204. Further, the MPU 201 sets the DRM processor for the network contents, 207, so as to perform decryption by using the content key Kc obtained by encrypting the encryption key EKcB.

Subsequently, the DRM processor for the network contents, 207 decrypts the contents downloaded into the storage unit for the network contents, 206, by using the content key Kc.

Subsequently, the DRM processor for the built-in contents, 204 reads out the decrypted contents, and it encrypts the read-out contents by using the set content key KdB. It stores the encrypted contents in the built-in content storage 203.

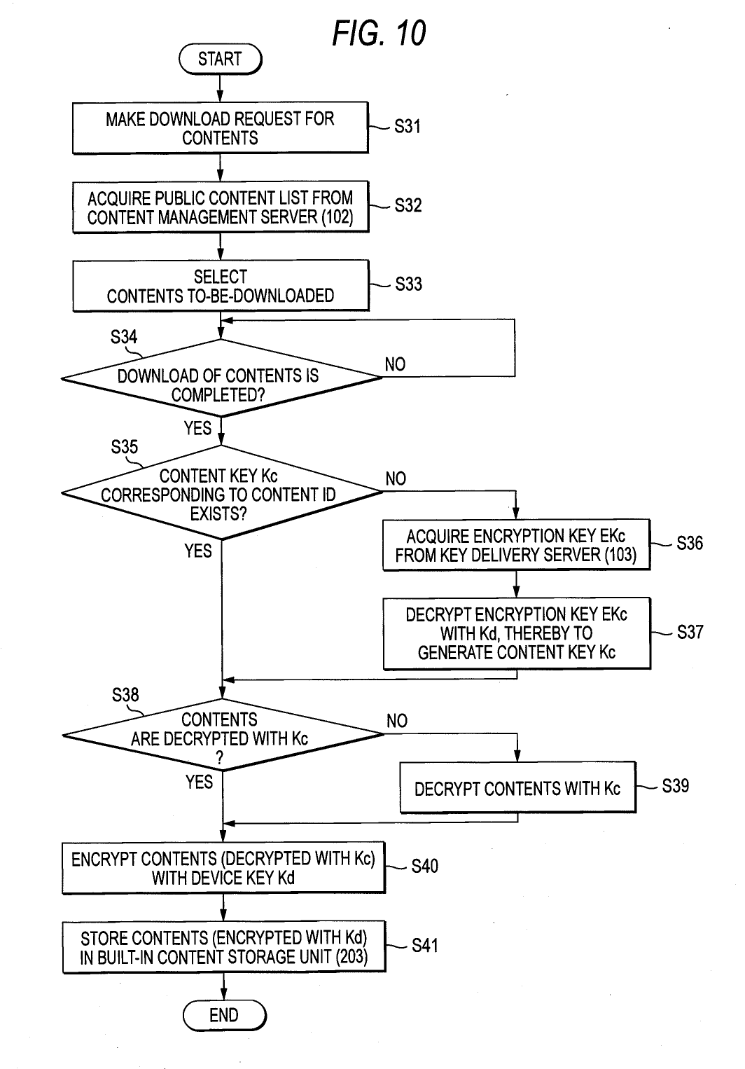

Next, the operation of the terminal device 101 in the case of downloading contents will be described with reference to FIG. 10. FIG. 10 is a flow chart showing the steps of downloading the contents in the embodiment of the present invention.

First, the MPU 201 confirms that a request for the download of the contents has been made by the user interface 209 (step S31). Subsequently, the MPU 201 inquires of the content management server 102 about a public content list and acquires the public content list (step S32). Subsequently, the MPU 201 confirms that the contents to be downloaded have been selected from within the public content list by the user interface 209 (step S33).

Subsequently, the MPU 201 collects content pieces from the plurality of terminal devices 101 which possess the selected contents, and it determines whether or not the download of the contents has been completed (step S34). When it has consequently been determined that the download of the contents has not been completed (“No” at the step S34), the ensuing processing is not performed until the completion is determined. On the other hand, when determined that the download of the contents has been completed (“Yes” at the step S34), the MPU 201 subsequently determines whether or not a content key Kc corresponding to the content ID of the selected contents is stored (step S35).

When it has consequently been determined that the content key Kc is not stored in the MPU 201 (“No” at the step S35), the MPU 201 transmits the selected content ID and the device key Kd stored in the DRM processor for the built-in contents, 204, to the key delivery server 103. In addition, the MPU 201 receives from the key delivery server 103, an encryption key EKc which is obtained in such a way that the content key Kc corresponding to the content ID is encrypted with the transmitted device key Kd (step S36). Subsequently, the MPU 201 decrypts the received encryption key EKc by using the device key Kd stored in the DRM processor for the built-in contents, 204, thereby to acquire the content key Kc (step S37).

On the other hand, when determined that the content key Kc is stored in the MPU 201 (“Yes” at the step S35), the MPU 201 subsequently determines whether or not the downloaded contents have been decrypted with the content key Kc (step S38).

When it has consequently been determined that the downloaded contents have not been decrypted with the content key Kc (“No” at the step S38), the MPU 201 reads out the contents downloaded into the storage unit for the network contents, 206, and it decrypts the read-out contents with the content key Kc by the DRM processor for the network contents, 207 (step S39).

On the other hand, when determined that the downloaded contents have been decrypted with the content key Kc (“Yes” at the step S38), the MPU 201 subsequently encrypts the decrypted contents with the device key Kd by the DRM processor for the built-in contents, 204 (step S40). Subsequently, the MPU 201 stores the encrypted contents, in the built-in content storage 203 (step S41).

The steps of downloading the contents stored in the other terminal device 101, from on the Internet are ended by the above steps.

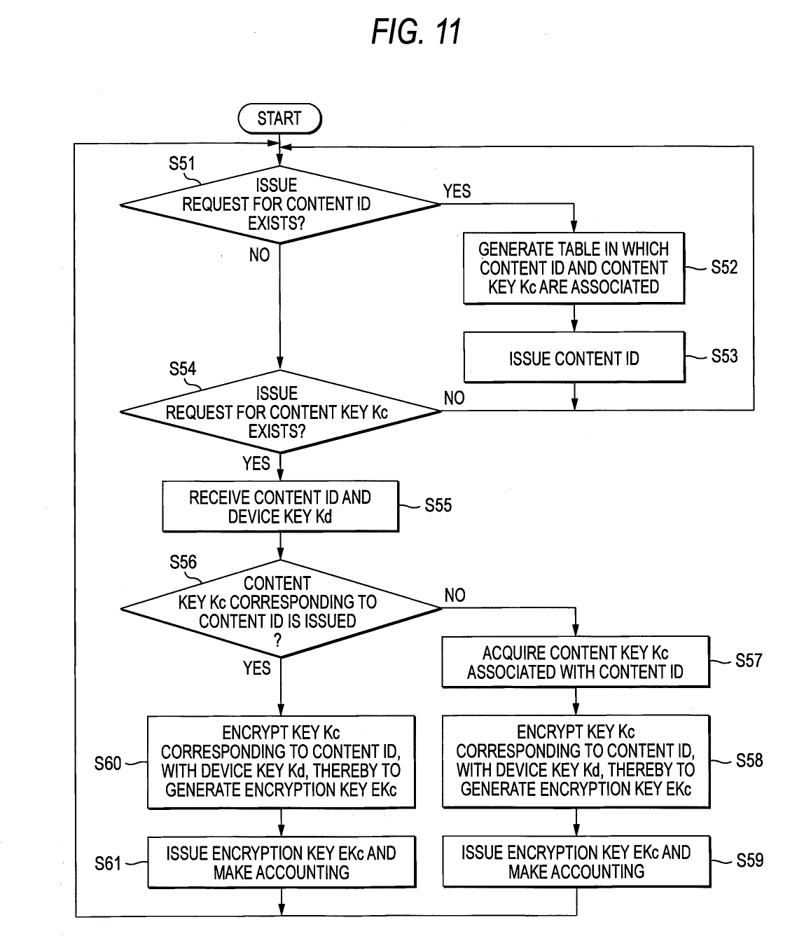

Next, the operation of the key delivery server 103 in the above cases of performing the upload and download of the contents will be described with reference to FIG. 11. FIG. 11 is a flow chart showing the operation of the key delivery server 103 in the embodiment of the present invention.

First, the key delivery server 103 determines whether or not there is an issue request for a content ID, from any of the plurality of terminal devices 101 connected through the Internet (step S51). When it has consequently been determined that there is the issue request for the content ID (“Yes” at the step S51), the key delivery server 103 generates a table for storing the content ID unique to the contents and a content key Kc in association (step S52). Subsequently, the key delivery server 103 issues the content ID to the terminal device 101 (step S53). On the other hand, when determined that there is not the issue request for the content ID (“No” at the step S51), the key delivery server 103 subsequently determines whether or not there is an issue request for the content key Kc (step S54).

When it has consequently been determined that there is not the issue request for the content key Kc (“No” at the step S53), the above steps from the step S51 are repeated. On the other hand, when determined that there is the issue request for the content key Kc (“Yes” at the step S54), the key delivery server 103 subsequently receives the content ID and the device key Kd of the terminal device 101 (step S55). Subsequently, the key delivery server 103 determines whether or not the content key Kc corresponding to the content ID has been issued to the terminal device 101 (step S56).

When it has consequently been determined that the content key Kc has not been issued (“No” at the step S56), that is, when the pertinent contents are to be uploaded, the key delivery server 103 subsequently acquires the content key Kc stored in association with the content ID (step S57). Subsequently, the key delivery server 103 encrypts the content key Kc corresponding to the content ID, with the received device key Kd, thereby to generate an encryption key EKc (step S58). Subsequently, the key delivery server 103 transmits the encryption key EKc to the terminal device 101 and simultaneously makes accounting (step S59).

On the other hand, when determined that the content key Kc has been issued (“Yes” at the step S56), that is, when the pertinent contents are to be downloaded, the key delivery server 103 subsequently encrypts the issued content key Kc corresponding to the content ID, with the received device key Kd, thereby to generate the encryption key EKc (step S60). Subsequently, the key delivery server 103 transmits the encryption key EKc to the terminal device 101 and simultaneously makes accounting (step S61). A fee charged on the terminal device 101 having downloaded the contents is paid into an account registered as the terminal device 101 having uploaded the pertinent contents.

The key delivery server 103 repeats the above steps.

According to the embodiment configured as stated above, contents are distributed via the P2P network, whereby the contents can be distributed easily without building any large-scale server. Key data associated with the contents to be distributed are managed by a server, whereby the copyright of the contents can be protected. Further, an accounting system is disposed conjointly with the delivery of the key data, whereby the sale of non-free contents by a public user is realized.

In a case where contents downloaded into a terminal device are to be stored in the terminal device itself, the contents are re-encrypted using a key unique to the terminal device itself, thereby to dispense with the labor of connecting the terminal device to a network again and acquiring the key data for decryption.

Although the embodiment according to the present invention has been described above, the present invention is not limited to the above-mentioned embodiment but can be variously modified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus comprising:
a communication module configured to communicate with a counterpart device, to receive data comprising an encrypted first content that has been encrypted by a first method from the counterpart device, and to transmit data comprising an encrypted second content that has been encrypted by a second key to the counterpart device;
a storage device;
a first processor configured to decrypt the encrypted first content and to encrypt the decrypted first content with a first key associated with the communication apparatus;
a second processor configured to decrypt the encrypted second content and to encrypt the decrypted second content with a second key corresponding with the second content; and
a controller configured to control the second processor to decrypt the encrypted second content that has been encrypted by the first key and stored in the storage device and to encrypt the decrypted second content with the second key before transmitting the second content to the counterpart device, and to control the first processor to decrypt the encrypted first content that has been encrypted by the first method received from the counter device and to encrypt the decrypted first content before storing the encrypted first content in the storage device.

2. The apparatus of claim 1,
wherein the communication module is configured to transmit the first key and a first identifier of the received content to a key server and to receive an encryption key from the key server, and
wherein the first processor is configured to decrypt the encryption key with the first key and to receive the second key.

3. The apparatus of claim 2,
wherein the communication module is configured to transmit the first identifier of the received content and a second identifier associated with the communication apparatus to a content management server after the content is encrypted by the second processor, and
wherein the communication module is configured to receive a list of the first identifier and the second identifier from the content management server.

4. The apparatus of claim 3, wherein the communication module is configured to divide the content into a plurality of content blocks and to transmit the content blocks to a plurality of counterpart devices, and
wherein the communication module is configured to receive the content blocks from the counterpart devices.

5. A content distribution system comprising:
a plurality of terminal apparatuses configured to transmit a first content and to receive a second content;
a key server configured to retain a key data corresponding with the content; and
a content management server configured to manage the content,
wherein each terminal apparatus comprises:
a communication module configured to communicate with a counterpart device, to receive data comprising an encrypted first content that has been encrypted by a first method from the counterpart device, and to transmit data comprising an encrypted second content that has been encrypted by a second key to the counterpart device;
a storage device;
a first processor configured to decrypt the encrypted first content and to encrypt the decrypted first content with a first key associated with the communication apparatus;
a second processor configured to decrypt the encrypted second content and to encrypt the decrypted second content with a second key corresponding with the second content; and
a controller configured to control the second processor to decrypt the encrypted second content that has been encrypted by the first key and stored in the storage device and to encrypt the decrypted second content with the second key before transmitting the second content to the counterpart device, and to control the first processor to decrypt the encrypted first content that has been encrypted by the first method received from the counter device and to encrypt the decrypted first content before storing the encrypted first content in the storage device,
wherein the key server is configured to generate the second key corresponding with a first identifier of the content transmitted from the terminal apparatuses, and
wherein the content management server is configured to register the first identifier and a second identifier unique to the respective terminal apparatuses.
